(19) United States
(12) Patent Application Publication
(10) Pub. No.: US 2018/0196580 A1
(43) Pub. Date: Jul. 12, 2018

(54) METHOD AND APPARATUS FOR BROWSING NEWS ON MOBILE TERMINAL

(71) Applicant: BEIJING QIHOO TECHNOLOGY COMPANY LIMITED, Beijing (CN)

(72) Inventors: Yanli WANG, Beijing (CN); Kai WU, Beijing (CN); Feng WANG, Beijing (CN)

(21) Appl. No.: 15/741,029

(22) PCT Filed: Jun. 20, 2016
(86) PCT No.: PCT/CN2016/086419

§ 371 Date: Dec. 29, 2017

(30) Foreign Application Priority Data
Jun. 30, 2015 (CN) 201510373652.4

(51) Int. Cl. G06F 3/0485; G06F 17/30; G06F 3/0481

(52) U.S. Cl. CPC G06F 3/0485; G06F 3/0481; G06F 17/30902

(57) ABSTRACT

A method and an apparatus for browsing news on a mobile terminal. The method comprises: acquiring and caching list data of a news list; deciding whether a news-dividing prompt mark appears on a current news details page; when it is decided that the news-dividing prompt mark appears, triggering an acquisition instruction according to an operation for the current news details page; acquiring data information of the divided news according to the acquisition instruction and the list data; and rendering the data information to obtain a news details page of the divided news.

### FIELD OF TECHNOLOGY

The present invention relates to the field of Internet technologies, and more particularly, to a method and an apparatus for browsing news on a mobile terminal.

### BACKGROUND

With the development of mobile Internet, people's reading habits are gradually changed from previously reading news on a personal computer (PC) to reading news on a mobile device such as a mobile phone or a tablet computer. Smooth reading experience is necessary for a user having higher requirements for news reading amount and depth of news. In an existing mobile news product, when the user clicks to enter into a news details page and reads the news, the user needs to click a Return button to return to a news list page to reselect the news.

In the process of using the existing mobile news product, it is found that after reading the current news, when the user wants to read a previous/next news, the user needs to first click the Return button to return to the news list page and click again to enter into the previous/next news. Such operation procedures are troublesome, and thus it is impossible to satisfy the user's requirement for smoothly reading the news without any restrictions.

### SUMMARY

In view of this, the present invention proposes a method and an apparatus for browsing news on a mobile terminal, mainly aiming at solving the problem that for a user, it is troublesome to perform operations while reading multiple pieces of news and it is impossible to smoothly read the news without any restrictions.

According to a first aspect of the present invention, the present invention provides a method for browsing news on a mobile terminal, comprising:

acquiring and caching list data of a news list;

deciding whether a news-dividing prompt mark appears on a current news details page;

triggering, when deciding that the news-dividing prompt mark appears, an acquisition instruction according to an operation for the current news details page:

acquiring data information of the divided news according to the acquisition instruction and the list data; and

rendering the data information to obtain a news details page of the divided news.

According to a second aspect of the present invention, the present invention provides an apparatus for browsing news on a mobile terminal, comprising:

an acquiring unit, configured to acquire and cache list data of a news list;

a deciding unit, configured to decide whether a news-dividing prompt mark appears on a current news details page:

a triggering unit, configured to trigger, when the deciding unit decides that the news-dividing prompt mark appears, an acquisition instruction according to an operation, decided by the deciding unit, for the current news details page;

the acquiring unit being configured to acquire data information of the divided news according to the acquisition instruction triggered by the triggering unit and the list data; and

a rendering unit, configured to render the data information acquired by the acquiring unit to obtain a news details page of the divided news.

By way of the above technical solutions, the method and apparatus for browsing news on a mobile terminal provided by the embodiments of the present invention can trigger an acquisition instruction by deciding whether a news-dividing prompt mark appears on a current news details page in combination with an operation for the current news details page, and is configured to acquire data information of a divided news and render the data information to obtain a news details page of the divided news. Compared with the prior art in which it is required to return to a news list page by clicking a Return button and then click to enter a previous/next news so as to continue reading, the present invention can directly enter a previous/next news details page by pulling up/pulling down a current news details page, greatly reduce operation steps in the process of reading the multiple pieces of news, and implement smoothly reading a lot of news without any restrictions.

Described above is merely an overview of the technical solution of the present invention. In order to more apparently understand the technical means of the present invention to implement in accordance with the contents of specification, and to more readily understand above and other objectives, features and advantages of the present invention, specific embodiments of the present invention are provided hereinafter.

### BRIEF DESCRIPTION OF THE DRAWINGS

FIG. 1 illustrates a flowchart of a method for browsing news on a mobile terminal according to an embodiment of the present invention;

FIG. 2 illustrates a schematic diagram of a position of a news-dividing prompt mark on a page according to an embodiment of the present invention;

FIG. 3 illustrates a schematic diagram of a position of another news-dividing prompt mark on a page according to an embodiment of the present invention;

FIG. 4 illustrates a composition block diagram of an apparatus for browsing news on a mobile terminal according to an embodiment of the present invention;

FIG. 5 is a block diagram of a computing device for executing the method for browsing news on a mobile terminal according to the present invention; and

FIG. 6 is a memory cell for maintaining or carrying a program code for implementing the method for browsing news on a mobile terminal according to the present invention.

### DESCRIPTION OF THE EMBODIMENTS

Exemplary embodiments of the disclosure will be described in detail with reference to the accompanying figures hereinafter. Although the accompanying drawings display the exemplary embodiments of the disclosure, it should be understood that the disclosure may be implemented in various forms but not limited by the embodiments set forth herein. Instead, these embodiments are provided to more thoroughly understand the disclosure, and completely convey the scope of the disclosure to those skilled in the art.

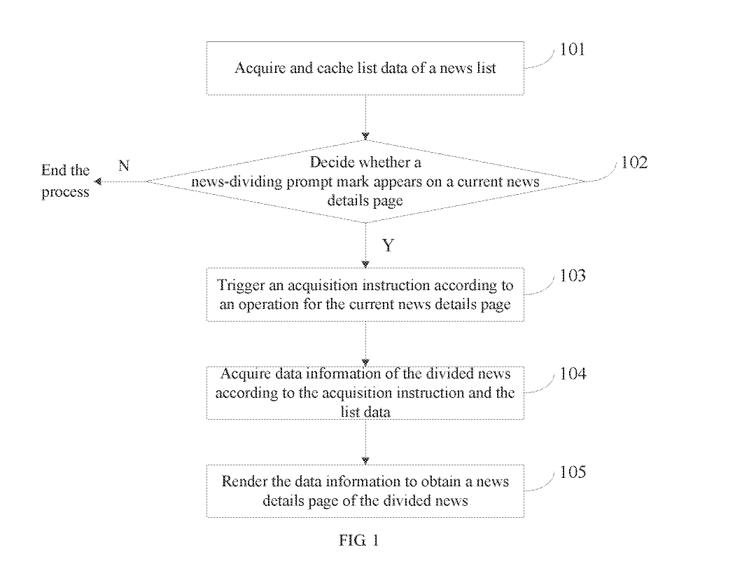

To solve the problem that for a user, it is troublesome to perform operations while reading multiple pieces of news and it is impossible to smoothly read the news without any restrictions, an embodiment of the present invention provides a method for browsing news on a mobile terminal. The method is focused on a client, and can directly enter a previous/next news details page by pulling up/pulling down a current news details page, greatly reduce operation steps in the process of reading the multiple pieces of news, and implement smoothly reading a lot of news without any restrictions. As shown in FIG. 1, the method comprises steps as follows.

Step 101: acquiring and caching list data of a news list.

In the process of reading news using a mobile news product, the user needs to click to enter a news channel page, which has news channels having different subjects, for example, an entertainment news channel, a social news channel, a sports news channel, and a scientific news channel, etc. Clicking to enter each news channel may obtain a news list of this channel. The news list comprises list data such as a news headline, a picture summary, a site, publication time and so on. The client acquires the list data and caches the list data locally, so that in the subsequent process of reading news, data such as the news headline, the picture summary, the site and the publication time of the previous or next news in the list data can be quickly acquired.

Step 102: deciding whether a news-dividing prompt mark appears on a current news details page.

In a traditional mobile news product, after reading the current news details page, it is required to click a Return button to return to the news list page and click again the previous or next news needing to be read in the news list page so as to continue reading relevant news. To avoid excessive click operations when reading the previous or next news, in Step 102 of the present invention, it is required to decide whether a news-dividing prompt mark appears on a current news details page. As one of conditions for reading the previous or next news, the news-dividing prompt mark may be combined with Step 103 to execute the operation of reading the previous or next news. The operation does not need to click the Return button, and thus can reduce the operation steps of reading the previous or next news.

Step 103: triggering an acquisition instruction according to an operation for the current news details page.

When it is decided that the news-dividing prompt mark appears in the Step 102, it is required to execute the Step 103 of triggering an acquisition instruction according to an operation for the current news details page. The operation for the current news details page in this step refers to a slip operation for the page. In the process of reading news, the slip operation mainly refers to pulling up or pulling down the page so as to read contents of different parts in the news.

Step 104: acquiring data information of the divided news according to the acquisition instruction and the list data.

After the acquisition instruction is triggered in Step 103, data information of the divided news may be acquired according to the acquisition instruction. In the Step 104, the client acquires data information of the previous or next news by invoking an interface function according to the acquired instruction and the list data. The data information comprises all contents of the news details page.

Step 105: rendering the data information to obtain a news details page of the divided news.

After the client acquires the data information of the previous or next news, the data information is rendered. In this way, the news details page of the divided news may be obtained and further read, so that it is not required to click the Return button to return to the news list page and then click the previous or next news for further reading, which greatly reduces cumbersome operation steps in the process of reading multiple pieces of news.

The method for browsing news on a mobile terminal provided by the embodiment of the present invention can trigger an acquisition instruction by deciding whether a news-dividing prompt mark appears on a current news details page in combination with an operation for the current news details page, and is configured to acquire data information of a divided news and render the data information to obtain the news details page of the divided news. Compared with the prior art in which it is required to return to a news list page by clicking a Return button and then click to enter a previous/next news so as to continue reading, the present invention can directly enter a previous/next news details page by pulling up/pulling down a current news details page, greatly reduce operation steps in the process of reading the multiple pieces of news, and implement smoothly reading a lot of news without any restrictions.

In order to better understand the method as shown in FIG. 1, as refinement and expansion of the foregoing implementations, detailed description of each step in FIG. 1 will be made in the embodiments of the present invention.

After the user enters into the news list via the client, the client acquires the list data of the current news list by invoking the interface function and caches the list data locally. The list data comprise: a news headline, a picture summary, a site, publication time and so on. After the user reads the current news details page and finishes the pull-up or pull-down operation, the client may quickly acquire data such as the news headline, the picture summary, the site and the publication time of the previous or next news from the locally cached list data. The data may appear, as the news preview content, in the news details page currently browsed by the user, so that the user can learn about the to-be-browsed news content in advance. As an alternative implementation, a $.ajax( ) function may be invoked to remotely acquire the list data.

In the traditional mobile news product, after the user reads the current news, the user needs to click the Return button to return to the news list page and then click to enter into the previous/next news to continue reading the previous/next news, which is cumbersome in operation procedure. To reduce the operation steps of reading multiple pieces of news, the method provided by the present invention can trigger an acquisition instruction by deciding whether a news-dividing prompt mark appears on a current news details page in combination with an operation for the current news details page, and acquire data information of a divided news and finally obtain the news details page of the divided news by rendering the data information.

When it is decided whether the news-dividing prompt mark appears on the current news details page, as an alternative implementation, a coordinate of the news-dividing prompt mark may be acquired, and it is decided whether the coordinate of the news-dividing prompt mark is positioned within a preset coordinate group. The preset coordinate group is a coordinate group of a visible area of a display screen when the client reads the news. When the coordinate of the news-dividing prompt mark falls within the preset coordinate group, it is decided that the news-dividing prompt mark appears on the current news details page, which indicates that the condition of reading other news is met. Finally whether it is required to acquire the data information of the divided news needs to be further decided according to the user's operation for the current news details page.

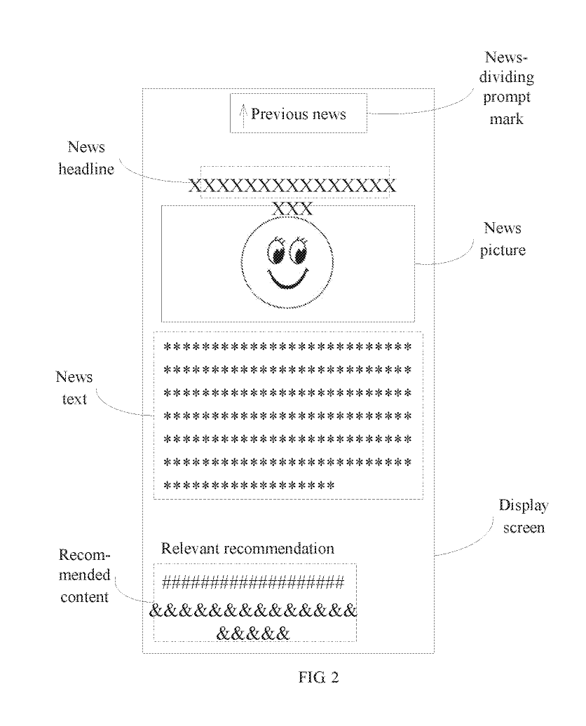

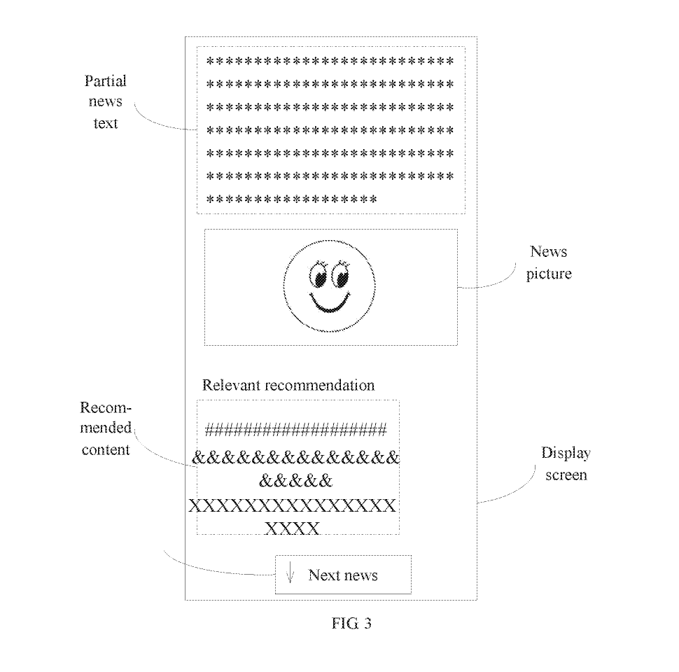

As an application scenario in the process of daily reading news, the news-dividing prompt mark in the embodiment of the present invention comprises a previous prompt mark and a next prompt mark. As shown in FIG. 2, the previous prompt mark typically is positioned above the news headline of the current news details page. As shown in FIG. 3, the next prompt mark typically is positioned beneath a recommended content of the current news details page. In the process of reading news, the user may browse the contents of different parts in the news details page by pulling up or pulling down the news details page. When the whole news is read by pulling the news details page up, the next prompt mark may appear beneath the recommended content of the current news details page. Similarly, the previous prompt mark may appear above the news headline of the current news details page by keeping pulling the news details page down. The pull-up or pull-down operation herein is another condition of determining whether to acquire the data information of the divided news in the present invention. The acquisition instruction cannot be triggered unless both two conditions are met, namely, the pull-up/pull-down operation is performed on the news details page and the next/previous prompt mark appears. The data information of the divided news is acquired by invoking the interface function according to the acquisition instruction. In practical application, the method used for invoking an interface depends on Function $.ajax( ) of zeptojs to read a remote interface.

Deciding whether the news-dividing prompt mark appears in the news details page is implemented by acquiring a coordinate of the news-dividing prompt mark and determining whether the coordinate is positioned within a preset coordinate group. The preset coordinate group is a coordinate set formed by each coordinate within the visible area of the display screen. A series of coordinates within the visible area of the display screen constitute the preset coordinate group. In the FIG. 2 and FIG. 3, the largest block represents the display screen, and a series of coordinates within the visible area of the display screen constitute the preset coordinate group in this embodiment. It is determined that the news-dividing prompt mark appears in the news details page when it is decided that the coordinate of the news-dividing prompt mark is positioned within the preset coordinate group.

The news-dividing prompt mark in this embodiment comprises a previous prompt mark and a next prompt mark. Therefore, it is required to decide whether the news-dividing prompt mark appears in the news details page is the previous prompt mark or the next prompt mark. At this moment, the preset coordinate group may comprise a first coordinate group and a second coordinate group. The first coordinate group is formed by each coordinate within an upper half part of the visible area of the display screen, and the second coordinate group is formed by each coordinate within a lower half part of the visible area of the display screen. When the coordinate of the news-dividing prompt mark falls within the first coordinate group, this indicates that the appeared news-dividing prompt mark is the previous prompt mark. When the coordinate of the news-dividing prompt mark falls within the second coordinate group, this indicates that the appeared news-dividing prompt mark is the next prompt mark. After it is decided that the previous prompt mark appears, the acquisition instruction for acquiring the data information of the previous news may be triggered via the pull-down operation. After it is decided that the next prompt mark appears, the acquisition instruction for acquiring the data information of the next news may be triggered via the pull-up operation.

When determining the pull-up/pull-down operation for the news details page, as an alternative implementation, the touch event of the current news details page may be listened, and variation of coordinate dragged by a touch point may be decided, so that it is determined the pull-up/pull-down operation is performed on the current news details page. For example, the most widely used mobile phone or tablet computer having an Android operating system is taken as an example, an event related to the touch screen may be implemented based on a listener, and the listener for a certain event is added using a setOnTouchListener( ) method. Herein, the type of the touch event may be acquired using a getAction( ) method of MotionEvent, comprising: ACTION_DOWN, ACTION_MOVE, ACTION_UP, and ACTION_CANCEL. The ACTION_DOWN refers to pressing the touch screen down, the ACTION_MOVE refers to moving a force-bearing point after pressing the touch screen down, the ACTION_UP refers to releasing the touch screen, and the ACTION_CANCEL is not directly triggered by the user. By way of deciding different operations of the user in combination with methods such as getRawX( ), getRawY( ), getX( ) and getY( ), and then invoking an onTouchEvent( ) method of a GestureDetector, the captured MotionEvent is handed over to the GestureDetector to analyze whether there is a proper callback function to process a gesture of the user.

Generally a news is longer, and thus multiple pull-up or pull-down operations are needed while reading the news. Taking the pull-up operation as an example, when the news is longer, during the pull-up operation while reading the news, since the news details page has not been pulled up to the end of the news, namely the next prompt mark has not appeared in the news details page, at this moment, the pull-down operation does not trigger the acquisition instruction, and the pull-up operation does not trigger the acquisition instruction unless the next prompt mark appears. Therefore it may be regarded that listening the touch event without the news-dividing prompt mark has no practical effect. As an alternative implementation, the process of listening the touch event of the current news details page is not continuously proceeded. Instead, listening the touch event is not started unless it is decided that the news-dividing prompt mark appears in the news details page. For example, when it is decided that the previous prompt mark appears, the listening event is started, and when subsequently it is decided that the pull-down operation is performed on the current news details page, the acquisition instruction for acquiring the data information of the previous news is triggered. When it is decided that the next prompt mark appears, the listening event is started, and when subsequently it is decided that the pull-up operation is performed on the current news details page, the acquisition instruction for acquiring the data information of the next news is triggered. This implementation may reduce waste of processing resources of the client caused by listening the touch event without the news-dividing prompt mark.

After the acquisition instruction is triggered, the client acquires the data information of the divided news according to the acquisition instruction, so that the user may directly enter into the news details page of the next/previous news by pulling up/down the news details page to read the news without clicking the Return button to return to the news list page and selecting the previous or next news to read. When the user directly enters into the news details page of the divided news via the pull-up or pull-down operation to read the news, it is impossible for the user to learn, in advance, about the subject of the to-be-read news, which does not conform to the user's habits of reading news. Therefore, as an alternative implementation, in the embodiments of the present invention, the data information of the divided news acquired according to the acquisition instruction comprises the data information of the news preview content and the data information of the news details page. The data information of the preview content of the previous or next news may be first acquired according to the acquisition instruction, and then the data information of the news details page of the previous or next news may be acquired. The data information of the preview content of the previous or next news is the data information of the previous or next news in the list data corresponding to the locally cached news list, comprising: a news headline, a news picture summary, and publication time, etc.

When acquiring the data information of the preview content, the client may quickly acquire, from the list data of the locally cached news list, data of the previous or next news, for example, the news headline, the picture summary, the site and the publication time, etc. When acquiring the data information of the previous or next news details page, the data information of the divided news may be acquired by invoking an interface function. In this implementation, the preview content of the divided news is first acquired via the pull-up or pull-down operation, so that the user can learn, in advance, about the subject of the to-be-read news, which conforms to the user's daily reading habits.

Furthermore, according to this implementation, when the news-dividing prompt mark appears in the news details page, the preview content of the previous/next news is acquired and displayed via the pull-down or pull-up operation. When the user is uninterested in the preview content and thus is unwilling to continue reading, the user may release the pull-up or pull-down operation, the client does not further acquire and display the news details page of the previous/next news, and the page is returned to the news details page of the current news. When the user is interested in the preview content and thus is willing to continue reading, the user may proceed the pull-up or pull-down operation, and the client may further acquire and display the news details page of the previous/next news. In this implementation, the preview content of the divided news is first acquired via the pull-up or pull-down operation, and then the details of the news are acquired via the pull-up or pull-down operation. In this way, the user can be allowed to selectively read.

After the data information of the divided news is acquired, the data information needs to be rendered to obtain a preview content and the news details page of the divided news. The data information may comprise a TXT file, an HTML file, an XML file, and JSON data. As an alternative implementation, page transcoding JSON data may be acquired via Ajax, and a DOM node is generated via JS analysis and is inserted into the page. In this way, rendering the page is finished. Alternatively, the page is updated using JS and HTML by way of Ajax. and an asynchronous request is sent to the server so as to execute the operation of updating the page. When the request is returned, the page may be correspondingly updated using JS and CSS instead of refreshing the whole page.

Herein it is to be further explained that a table entry of each news in the news list corresponds to a complete news in the news details page. The data information (the data information of the preview content and/or the data information of the news details page) of the previous/next news acquired after reading the current news details page corresponds, one to one, to the data information (the data information of the preview content and/or the data information of the news details page) of the previous/next news of the current news in the news list.

According to the embodiment of the present invention, after it is decided that the news-dividing prompt mark appears in the current news details page, a touch event for the current news details page is started to listen, so that processing resources can be saved for the client. Furthermore, by pulling up or pulling down the current news details page, the preview content of the divided news is displayed on the page, and then the details page of the divided news is displayed, which can conform to the user's habits of reading news, and can allow the user to selectively read.

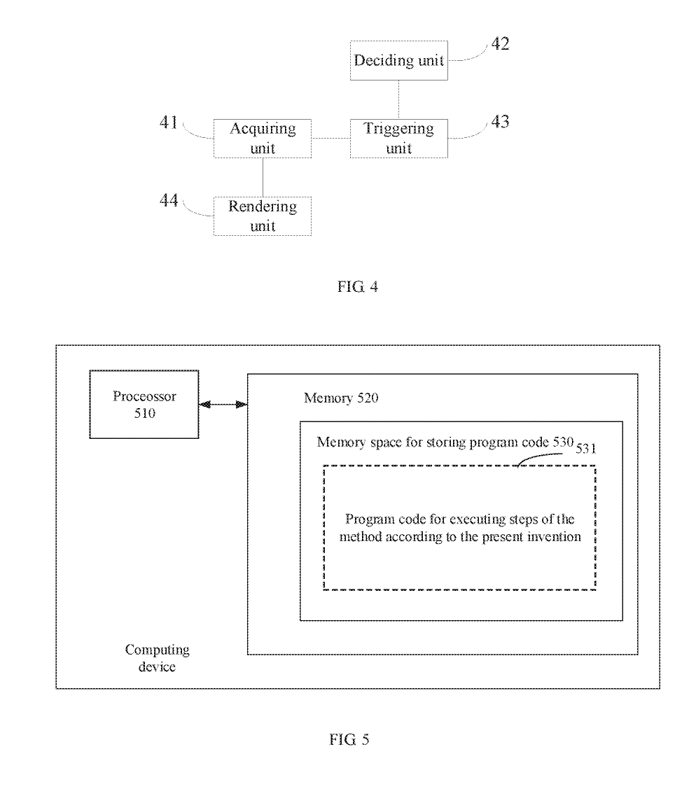

Further, as implementation of the method as shown in FIG. 1, an embodiment of the present invention further provides an apparatus for browsing news on a mobile terminal, wherein the apparatus may be positioned in a client. As shown in FIG. 4, the apparatus comprises: an acquiring unit 41, a deciding unit 42, a triggering unit 43, and a rendering unit 44.

The acquiring unit 41 is configured to acquire and cache list data of a news list.

The deciding unit 42 is configured to decide whether a news-dividing prompt mark appears on a current news details page.

The triggering unit 43 is configured to trigger, when the deciding unit 42 decides that the news-dividing prompt mark appears, an acquisition instruction according to an operation, decided by the deciding unit 42, for the current news details page.

The acquiring unit 41 is configured to acquire data information of the divided news according to the acquisition instruction triggered by the triggering unit 43 and the list data.

The rendering unit 44 is configured to render the data information acquired by the acquiring unit 41 to obtain a news details page of the divided news.

Further, the acquiring unit 41 is configured to acquire the list data of the news list by invoking an interface function, and cache the list data of the news list locally.

Further, the deciding unit 42 is configured to acquire a coordinate of the news-dividing prompt mark, and decide whether the coordinate is positioned within a preset coordinate group.

Further, the deciding unit 42 is configured to acquire a coordinate of a previous prompt mark and a coordinate of a next prompt mark, and decide whether the coordinate is positioned within the preset coordinate group.

Further, the deciding unit 42 is configured to decide to pull the current news details page up and pull the current news details page down.

Further, the triggering unit 43 is configured to decide a variation of coordinate dragged by a touch point by listening, by the deciding unit 42, a touch event for the current news details page, and trigger the acquisition instruction after determining a pull-up operation or pull-down operation for the current news details page.

Further, the triggering unit 43 is configured to trigger an acquisition instruction of acquiring data information of a previous news when the deciding unit 42 decides that a previous prompt mark appears and decides that the pull-down operation is performed on the current news details page.

The triggering unit 43 is configured to trigger an acquisition instruction of acquiring data information of a next news when the deciding unit 42 decides that a next prompt mark appears and decides that the pull-up operation is performed on the current news details page.

Further, the acquiring unit 41 is configured to acquire data information of a news preview content and data information of a news details page. The news preview content comprises a news headline and a news picture summary.

Further, the acquiring unit 41 is configured to acquire the data information of the previous news or the next news by invoking the interface function according to the cached list data.

The apparatus for browsing news on a mobile terminal provided by the embodiment of the present invention can trigger an acquisition instruction by deciding whether a news-dividing prompt mark appears on a current news details page in combination with an operation for the current news details page, and is configured to acquire data information of a divided news and render the data information to obtain a news details page of the divided news. Compared with the prior art in which it is required to return to a news list page by clicking a Return button and then click to enter a previous/next news so as to continue reading, the present invention can directly enter a previous/next news details page by pulling up/pulling down a current news details page, greatly reduce operation steps in the process of reading the multiple pieces of news, and implement smoothly reading a lot of news without any restrictions.

Furthermore, according to the embodiments of the present invention, after it is decided that the news-dividing prompt mark appears in the current news details page, a touch event for the current news details page is started to listen, so that processing resources can be saved for the client. By pulling up or pulling down the current news details page, the preview content of the divided news is displayed on the page, and then the details page of the divided news is displayed, which can conform to the user's habits of reading news.

Among the foregoing embodiments, description of various embodiments may be focused on differentially, and a part not expatiated in a certain embodiment may refer to related description of other embodiments.

It is to be understood that cross reference may be made to the relevant features of the above method and apparatus. Furthermore, the “first”, “second” and so on in the above embodiments are used to differentiate the embodiments but do not represent superiorities and inferiorities of the embodiments.

Persons skilled in the art may clearly understand that for a convenient and concise description, a concrete work process of systems, apparatuses and units described above may refer to a corresponding process of the foregoing method embodiments, which is not repeated anymore herein.

Algorithm and display provided herein are not inherently related to a particular computer, virtual system or other equipment. Various general systems may also be used with the teaching based on the present invention. According to the above description, the required structure for constructing such a system is obvious. In addition, the present invention is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the present invention, various features of the present invention may sometimes be grouped together into a single embodiment, accompanying figure or description thereof. However, the method of this disclosure should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (comprising claims, abstract and accompanying figures) and all the processes or units of any methods or devices as disclosed herein. Unless otherwise definitely stated, each of features disclosed in specification (comprising claims, abstract and accompanying figures) may be taken place with an alternative feature having same, equivalent or similar purpose.

In addition, it should be understood by those skilled in the art, although some embodiments as discussed herein comprise some features comprised in other embodiment rather than other feature, combination of features in different embodiment means that the combination is within a scope of the present invention and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the title of invention (for example, a device for determining hyperlink ranks in a website) according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

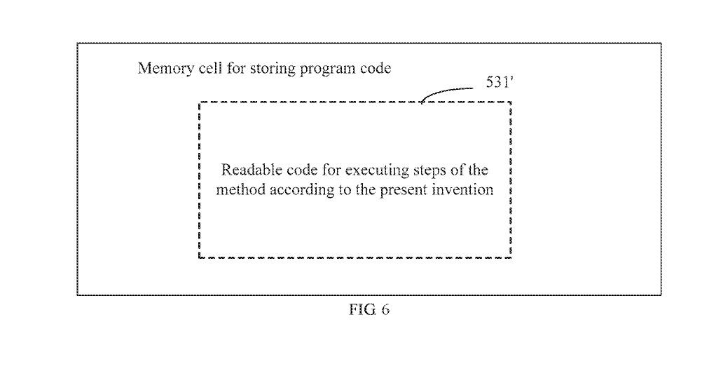

For example, FIG. 5 illustrates a computing device for executing the method for browsing news on a mobile terminal according to the present invention. Traditionally, the computing device comprises a processor 510 and a program product or a readable medium in form of a memory 520. The memory 520 could be electronic memories such as flash memory, EEPROM (Electrically Erasable Programmable Read-Only Memory), EPROM or ROM. The memory 520 has a memory space 530 for executing program codes 531 of any steps in the above methods. For example, the memory space 530 for program codes may comprises respective program codes 531 for implementing the respective steps in the method as mentioned above. These program codes may be read from and/or be written into one or more program products. These program products comprise program code carriers such as memory card. These program products are usually the portable or stable memory cells as shown in reference FIG. 6. The memory cells may be provided with memory sections, memory spaces, etc., similar to the memory 520 of the computer device as shown in FIG. 5. The program codes may be compressed for example in an appropriate form. Usually, the memory cell comprises readable codes 531′ which can be read for example by processors 510. When these codes are operated on the computing device, the computing device may execute respective steps in the method as described above.

It should be noted that the above-described embodiments are intended to illustrate but not to limit the present invention, and alternative embodiments can be devised by a person skilled in the art without departing from the scope of claims as appended. In the claims, no reference mark between round brackets shall impose restriction on the claims. The word “comprises” does not exclude a component or step not listed in the claims. The wording “a” or “an” in front of an element does not exclude the presence of a plurality of such elements. The present invention may be realized by way of hardware comprising a number of different components and by way of a suitably programmed computer. In the unit claim listing a plurality of devices, some of these devices may be embodied in the same hardware. The wordings “first”, “second”, and “third”, etc. do not denote any order. These wordings can be construed as naming.

1. A method for browsing news on a mobile terminal, comprising:
acquiring and caching list data of a news list;
deciding whether a news-dividing prompt mark appears on a current news details page;
triggering, when deciding that the news-dividing prompt mark appears, an acquisition instruction according to an operation for the current news details page;
acquiring data information of the divided news according to the acquisition instruction and the list data; and
rendering the data information to obtain a news details page of the divided news.

2. The method according to claim 1, wherein the acquiring and caching list data of a news list comprises: acquiring the list data of the news list by invoking an interface function, and caching the list data of the news list locally.

3. The method according to claim 1, wherein the deciding whether a news-dividing prompt mark appears on a current news details page comprises: acquiring a coordinate of the news-dividing prompt mark, and deciding whether the coordinate is positioned within a preset coordinate group.

4. The method according to claim 1, wherein the news-dividing prompt mark comprises:
a previous prompt mark, positioned above a news headline of the current news details page; or
a next prompt mark, positioned beneath a recommended content of the current news details page.

5. The method according to claim 1, wherein the operation for the current news details page comprises: pulling the current news details page up and pulling the current news details page down.

6. The method according to claim 1, wherein the triggering an acquisition instruction according to an operation for the current news details page comprises:
deciding a variation of coordinate dragged by a touch point by listening a touch event for the current news details page, and triggering the acquisition instruction after determining a pull-up operation or pull-down operation for the current news details page.

7. The method according to claim 1, wherein the triggering, when deciding that the news-dividing prompt mark appears, an acquisition instruction according to an operation for the current news details page comprises:
triggering an acquisition instruction of acquiring data information of a previous news when deciding that the previous prompt mark appears and deciding that the pull-down operation is performed on the current news details page; and
triggering an acquisition instruction of acquiring data information of a next news when deciding that the next prompt mark appears and deciding that the pull-up operation is performed on the current news details page.

8. The method according to claim 1, wherein the data information of news comprises: data information of a news preview content, and data information of a news details page; and
the news preview content comprises: a news headline and a news picture summary.

9. The method according to claim 1, wherein the acquiring data information of the divided news according to the acquisition instruction and the list data comprises:
acquiring the data information of the previous news or the next news by invoking the interface function according to the cached list data.

10. The method according to claim 1, wherein the data information comprises a TXT file, an HTML file, an XML file, and JSON data.

11. A computing device, comprising:
a memory having instructions stored thereon;
a processor configured to execute the instructions to perform operations for browsing news on a mobile terminal, the operations comprising:
acquiring and caching list data of a news list;
deciding whether a news-dividing prompt mark appears on a current news details page;
triggering, when deciding that the news-dividing prompt mark appears, an acquisition instruction according to an operation for the current news details page;
acquiring data information of the divided news according to the acquisition instruction and the list data; and
rendering the data information to obtain a news details page of the divided news.

12. The computing device according to claim 11, wherein the acquiring and caching list data of a news list comprises: acquiring the list data of the news list by invoking an interface function, and caching the list data of the news list locally.

13. The computing device according to claim 11, wherein the deciding whether a news-dividing prompt mark appears on a current news details rage comprises: acquiring a coordinate of the news-dividing prompt mark, and deciding whether the coordinate is positioned within a preset coordinate group.

14. The computing device according to claim 11, wherein the deciding whether a news-dividing prompt mark appears on a current news details page comprises: acquiring a coordinate of a previous prompt mark and a coordinate of a next prompt mark, and deciding whether the coordinate is positioned within a preset coordinate group.

15. The apparatus according to claim 11, wherein the deciding whether a news-dividing prompt mark appears on a current news details page comprises: deciding to pull the current news details page up and pull the current news details page down.

16. The apparatus according to claim 11, wherein the triggering, when deciding that the news-dividing prompt mark appears, an acquisition instruction according to an operation for the current news details page comprises: triggering the acquisition instruction after deciding a variation of coordinate dragged by a touch point by listening a touch event for the current news details page and determining a pull-up operation or pull-down operation for the current news details page.

17. The computing device according to claim 1, wherein the triggering, when deciding that the news-dividing prompt mark appears, an acquisition instruction according to an operation for the current news details page comprises: triggering an acquisition instruction of acquiring data information of a previous news when deciding that the previous prompt mark appears and deciding that the pull-down operation is performed on the current news details page; and
triggering an acquisition instruction of acquiring data information of a next news when deciding that the next prompt mark appears and deciding that the pull-up operation is performed on the current news details page.

18. The computing device according to claim 1, wherein the acquiring and caching list data of a news list comprises: acquiring data information of a news preview content and data information of a news details page; and the news preview content comprises a news headline and a news picture summary.

19. The computing device according to claim 11, wherein the acquiring and caching list data of a news list comprises: acquiring the data information of the previous news or the next news by invoking the interface function according to the cached list data.

20. (canceled)

21. A non-transitory computer-readable medium having computer programs stored thereon that, when executed by one or more processors of a computing device, cause the computing device to perform operations for browsing news on a mobile terminal, the operations comprising:
acquiring and caching list data of a news list;
deciding whether a news-dividing prompt mark appears on a current news details page;
triggering, when deciding that the news-dividing prompt mark appears, an acquisition instruction according to an operation for the current news details page;
acquiring data information of the divided news according to the acquisition instruction and the list data; and
rendering the data information to obtain a news details page of the divided news.
